(19) United States
(12) Patent Application Publication
(10) Pub. No.: US 2025/0212833 A1
(43) Pub. Date: Jul. 3, 2025

(54) PET SHEET AND PACKAGE

(71) Applicant: Unicharm Corporation, Ehime (JP)

(72) Inventors: Mami Nashiki, Kanonji-shi (JP); Mai Iwata, Kanonji-shi (JP)

(73) Assignee: Unicharm Corporation, Ehime (JP)

(21) Appl. No.: 19/083,116

(22) Filed: Mar. 18, 2025

Related U.S. Application Data
(63) Continuation of application No. PCT/JP2023/033397, filed on Sep. 13, 2023.

(30) Foreign Application Priority Data
Sep. 21, 2022 (JP) 2022-150099

(51) Int. Cl. A01K 1/01; A01K 1/015; B32B 3/06; B32B 3/30; B32B 5/02; B32B 27/12; B32B 27/32

(52) U.S. Cl. CPC A01K 1/0107; A01K 1/0157; B32B 3/06; B32B 3/30; B32B 5/022; B32B 27/12; B32B 27/32; B32B 2307/726; B32B 2307/7265; B32B 2307/748; B32B 2471/04

(57) ABSTRACT

The pet sheet 1 includes a main body portion 10 including a top sheet 2, a back sheet 3, and an absorbent body 4. On a back surface 3a of the back sheet 3, a bonding surface 7a bonded to a treatment sheet 100 is provided in a state of being exposed to the outside. In the main body portion 10, a folding line L1 for folding the main body portion 10 in half is formed such that the back surface 3a becomes an inner side. The bonding surface 7a is configured such that a first part 11 positioned on one side with respect to the folding line L1 is positioned above a second part 12 positioned on the other side with respect to the folding line L1, and in a case where only the first part 11 of the main body portion 10 in the folded-in-half state folded in half along the folding line L1 is retained, the second part 12 is naturally separated from the first part 11 and the folded-in-half state is released.

### TECHNICAL FIELD

The present disclosure relates to a pet sheet and a package.

### BACKGROUND ART

Conventionally, an animal excreta treatment sheet (hereinafter referred to as a “treatment sheet”.) for treating excreta excreted by a pet such as a dog is known (for example, refer to Patent Literature 1).

### CITATION LIST

### Patent Literature

Patent Literature 1: Japanese Unexamined Patent Publication No. 2003-92940

### SUMMARY OF INVENTION

### Technical Problem

Pets such as dogs tend to excrete while avoiding urine traces on the treatment sheet. For this reason, there is a problem in which pets urinate in an abnormal urination posture in an attempt to avoid urine traces, resulting in urination outside the treatment sheet. In order to avoid such a problem, there are many users who replace the treatment sheet with a new sheet although the treatment sheet still has a usable margin region (region capable of absorbing new urine). However, replacing a still usable treatment sheet with a new sheet is not appropriate from the viewpoint of environmental protection, and the user himself or herself feels guilt.

As a method for solving the above problem, a method is known in which a parent sheet (treatment sheet) and a sub-sheet (a pet sheet smaller than the parent sheet) are used in combination, and in a case where a pet excretes (urinates) on the sub-sheet, only the sub-sheet is replaced. According to this method, it becomes possible to use a single treatment sheet for a longer period than before, thereby achieving improvements from the viewpoint of both environmental protection and user mental well-being. On the other hand, in order to stick the pet sheet on the treatment sheet as described above, certain tasks such as taking out the pet sheet from the package or the like, making the state of the pet sheet attachable to the treatment sheet, and then sticking the pet sheet to the treatment sheet are required. When the time and effort required for such tasks is large, the user may feel a burden on the action of sticking the pet sheet, which could hinder the promotion of the use of pet sheets.

Therefore, an object of one aspect of the present disclosure is to provide a pet sheet capable of effectively reducing the time and effort of the user at the time of using the pet sheet and promoting the use of the pet sheet, and a package accommodating the pet sheet.

### Solution to Problem

According to an aspect of the present disclosure, there is provided a pet sheet used by overlapping with a region where excreta is absorbed in an animal excreta treatment sheet that absorbs the excreta of animals, the pet sheet including: a main body portion including a liquid-permeable top sheet, a back sheet positioned on a side opposite to the top sheet, and an absorbent body disposed between the top sheet and the back sheet, in which the back sheet has a back surface facing a side opposite to a side facing the top sheet, a bonding surface to be bonded to the animal excreta treatment sheet is provided on the back surface in a state of being exposed to the outside, a folding line for folding the main body portion in half is formed on the main body portion such that the back surface becomes an inner side, and the bonding surface is configured such that, when a first part positioned on one side with respect to the folding line in the main body portion is positioned above a second part positioned on the other side with respect to the folding line in the main body portion, in a case where only the first part of the main body portion, which is in a folded-in-half state of being folded in half along the folding line, is retained, the second part is naturally separated from the first part, thereby releasing the folded-in-half state.

According to another aspect of the present disclosure, there is provided a pet sheet used by overlapping with a region where excreta is absorbed in an animal excreta treatment sheet that absorbs the excreta of animals, the pet sheet including: a main body portion including a liquid-permeable top sheet, a back sheet positioned on a side opposite to the top sheet, and an absorbent body disposed between the top sheet and the back sheet, in which the back sheet has a back surface facing a side opposite to a side facing the top sheet, a bonding surface to be bonded to the animal excreta treatment sheet is provided on the back surface in a state of being exposed to the outside, a folding line that enables the main body portion to be folded in half is formed on the main body portion such that the back surface becomes an inner side, the bonding surface is disposed such that, in a folded-in-half state folded in half along the folding line, a part of the bonding surface disposed in a first part of the main body portion positioned on one side with respect to the folding line faces a part of the bonding surface disposed in a second part of the main body portion positioned on the other side of the folding line, and the edge portion of the main body portion parallel to the folding line is formed by a flap portion where the absorbent body is not provided.

According to still another aspect of the present disclosure, there is provided a package accommodating a plurality of pet sheets used by overlapping with a region where excreta is absorbed in an animal excreta treatment sheet which absorbs excreta of an animal, in which the pet sheet includes: a liquid-permeable top sheet; a back sheet positioned on a side opposite to the top sheet; and an absorbent body disposed between the top sheet and the back sheet, the back sheet has a back surface facing a side opposite to a side facing the top sheet, a bonding surface to be bonded to the animal excreta treatment sheet is provided on the back surface, and a plurality of the pet sheets accommodated in the package are arranged such that the top sheets of the adjacent pet sheets are in surface contact with each other in a folded state where each of the back surfaces becomes an inner side.

### Advantageous Effects of Invention

According to the present disclosure, it is possible to provide a pet sheet capable of effectively reducing the time and effort of the user at the time of using the pet sheet and promoting the use of the pet sheet, and a package accommodating the pet sheet.

### BRIEF DESCRIPTION OF DRAWINGS

FIG. 1 is a view showing a usage example of a pet sheet according to an embodiment.

FIG. 2 is a plan view of the pet sheet as viewed from a front surface side.

FIG. 3 is a plan view of the pet sheet as viewed from a back surface side.

FIG. 4 is a schematic view of a cross-sectional structure of the pet sheet taken along line IV-IV in FIG. 2.

FIG. 5 is a schematic view of a cross-sectional structure of the pet sheet taken along line V-V in FIG. 2.

FIG. 6 is a plan view showing a folded-in-half state of the pet sheet.

FIG. 7 is a schematic view of the pet sheet transitioning from a folded-in-half state to an unfolded state as viewed from the side.

FIG. 8 is a view showing a structure example of a bonding portion provided on a back surface of the pet sheet.

FIG. 9 is a view showing an arrangement example of a bonding surface provided on the back surface of the pet sheet.

FIG. 10 is a view showing an arrangement example of the bonding surface provided on the back surface of the pet sheet.

FIG. 11 is a view showing an arrangement example of the bonding surface provided on the back surface of the pet sheet.

FIG. 12 is a view showing an arrangement example of the bonding surface provided on the back surface of the pet sheet.

FIG. 13 is a plan view of a first modification example of a main body portion as viewed from a top sheet side.

FIG. 14 is a schematic view of the pet sheet of FIG. 13 in a folded-in-quarters state as viewed from the side.

FIG. 15 is a schematic view of a cross-sectional structure of a package according to the embodiment.

FIG. 16 is a plan view of a second modification example of the main body portion as viewed from the back sheet side.

FIG. 17 is a plan view showing a folded-in-half state of the pet sheet of FIG. 16.

### DESCRIPTION OF EMBODIMENTS

At least the following Aspects 1 to 21 will become apparent from the description of the present specification and the accompanying drawings.

### (Aspect 1)

A pet sheet used by overlapping with a region where excreta is absorbed in an animal excreta treatment sheet that absorbs the excreta of animals, the pet sheet including
a main body portion including a liquid-permeable top sheet, a back sheet positioned on a side opposite to the top sheet, and an absorbent body disposed between the top sheet and the back sheet, in which
the back sheet has a back surface facing a side opposite to a side facing the top sheet,
a bonding surface to be bonded to the animal excreta treatment sheet is provided on the back surface in a state of being exposed to an outside,
a folding line for folding the main body portion in half is formed on the main body portion such that the back surface becomes an inner side, and
the bonding surface is configured such that, when a first part positioned on one side with respect to the folding line in the main body portion is positioned above a second part positioned on an other side with respect to the folding line in the main body portion, in a case where only the first part of the main body portion, which is in a folded-in-half state of being folded in half along the folding line, is retained, the second part is naturally separated from the first part, thereby releasing the folded-in-half state.

In Aspect 1, when the pet sheet in the folded-in-half state is used, the folded-in-half state can be released only by holding the pet sheet with one hand without applying a special force, and the pet sheet can be attached to the animal excreta treatment sheet. In addition, the bonding surface provided on the back surface of the pet sheet is exposed to the outside, a cover sheet (release paper or the like) or the like covering the bonding surface is not provided, and thus the time and effort of peeling off the cover sheet is not required when the pet sheet is used. Therefore, according to the pet sheet, the time and effort of the user at the time of using the pet sheet can be effectively reduced, and the use of the pet sheet can be promoted.

### (Aspect 2)

The pet sheet according to Aspect 1, in which
the bonding surface is disposed such that at least a part of the bonding surface disposed in the first part and a part of the bonding surface disposed in the second part face each other in the folded-in-half state, and
a bonding strength between the bonding surfaces is set such that the second part is separated from the first part by its own weight of the second part and the folded-in-half state is released when the first part is positioned above the second part, in a case where only the first part of the pet sheet in the folded-in-half state is retained.

According to Aspect 2, by setting the bonding strength between the bonding surfaces such that the folded-in-half state is released by its own weight of the second part, it is possible to realize a configuration that achieves the effect of Aspect 1 described above while making it possible to dispose the bonding surfaces such that the bonding surfaces are in contact with each other in the folded-in-half state (that is, while securing the degree of freedom in the arrangement of the bonding surfaces).

### (Aspect 3)

The pet sheet according to Aspect 1, in which
the bonding surface is disposed on the back surface such that the bonding surfaces do not face each other in the folded-in-half state.

According to Aspect 3, since it is possible to prevent the bonding surfaces from being bonded to each other in the folded-in-half state, it is possible to easily realize a configuration that achieves the effect of Aspect 1 described above.

### (Aspect 4)

The pet sheet according to any one of Aspects 1 to 3, in which
in a region along a second edge portion on a side opposite to a first edge portion along the folding line of the main body portion in the folded-in-half state, a length along the second edge portion of a bonding region provided with the bonding surface is shorter than a length along the second edge portion of a non-bonding region which is not provided with the bonding surface.

According to Aspect 4, in the non-bonding region in the region along the second edge portion, it is possible to achieve a structure in which a finger can be easily inserted into the inner side of the main body portion in the folded-in-half state (between the first part and the second part), and thus it is easy to release the folded-in-half state and make the pet sheet be in a state of being attachable to the animal excreta treatment sheet.

### (Aspect 5)

The pet sheet according to any one of Aspects 1 to 4, in which
in a region along a third edge portion connected to a first edge portion along the folding line of the main body portion in the folded-in-half state and intersecting the first edge portion, a length along the third edge portion of a bonding region provided with the bonding surface is shorter than a length along the third edge portion of a non-bonding region which is not provided with the bonding surface.

According to Aspect 5, in the non-bonding region in the region along the third edge portion, it is possible to achieve a structure in which a finger can be easily inserted into the inner side of the main body portion in the folded-in-half state (between the first part and the second part), and thus it is easy to release the folded-in-half state and make the pet sheet be in a state of being attachable to the animal excreta treatment sheet.

### (Aspect 6)

The pet sheet according to any one of Aspects 1 to 5, in which
the bonding surface is disposed not to overlap with the folding line.

According to Aspect 6, since the bonding surface is not deformed (not folded) even when the main body portion is in a folded-in-half state, the parallel state of the bonding surface can be appropriately maintained. As a result, it is possible to avoid the bonding function of the bonding surface with respect to the animal excreta treatment sheet from being impaired by being in the folded-in-half state.

### (Aspect 7)

The pet sheet according to any one of Aspects 1 to 6, in which
the bonding surface is a hook surface provided with a plurality of hooks.

According to Aspect 7, it is possible to easily realize a configuration in which the bonding surface is exposed to the outside (that is, a configuration in which it is unnecessary to cover the bonding surface with a cover sheet such as a release paper in a state before use of the pet sheet).

### (Aspect 8)

The pet sheet according to Aspect 7, in which
a height of the hook is 45 μm to 350 μm.

According to Aspect 8, by setting the height of the hook within the above range and suppressing the bonding strength of the hook to a certain level or less, it is possible to suitably realize a configuration in which the main body portion is easily opened from the folded-in-half state while enabling the pet sheet to be bonded with respect to the animal excreta treatment sheet.

### (Aspect 9)

The pet sheet according to Aspect 7 or 8, in which
the back surface has a non-bonding surface which is not provided with the bonding surface, and
at least a part facing the bonding surface in the folded-in-half state in the non-bonding surface is formed of a film that does not engage with the hook.

According to Aspect 9, since the bonding surfaces (hooks) and the non-bonding surfaces (films) facing each other in the folded-in-half state can be reliably prevented from being bonded (engaged), it is possible to suitably realize a configuration in which the main body portion easily changes from the folded-in-half state to the unfolded state.

### (Aspect 10)

The pet sheet according to any one of Aspects 7 to 9, in which
the hook surface is formed by a surface of a hook sheet adhering to the back surface,
the hook sheet has a sheet edge portion along an edge portion different from a first edge portion along the folding line of the main body portion in the folded-in-half state, and
the sheet edge portion does not adhere to the back surface.

According to Aspect 10, since the back sheet and the sheet edge portion are separated from each other without adhering to each other, it is possible to realize a configuration in which the main body portion can be easily opened from the folded-in-half state.

### (Aspect 11)

The pet sheet according to any one of Aspects 1 to 10, in which
in the main body portion, two second folding lines for further folding the pet sheet in half again from the folded-in-half state into a folded-in-quarters state are formed on both sides sandwiching the folding line.

According to Aspect 11, since the pet sheet can be folded more compactly, the storage property and the storage ability of the pet sheet can be improved.

### (Aspect 12)

The pet sheet according to Aspect 11, in which
the bonding surface is disposed not to overlap with both the folding line and the two second folding lines.

According to Aspect 12, since the bonding surface is not deformed (not folded) even when the main body portion is in a folded-in-quarters state, the parallel state of the bonding surface can be appropriately maintained. As a result, it is possible to avoid the bonding function of the bonding surface with respect to the animal excreta treatment sheet from being impaired by being in the folded-in-quarters state.

### (Aspect 13)

The pet sheet according to Aspect 11 or 12, in which
the two second folding lines include a third folding line for folding the main body portion such that the top sheet becomes an inner side in the folded-in-quarters state, and
the bonding surface is provided at least in a region on a side opposite to a side where the folding line is positioned with respect to the third folding line.

In Aspect 13, the bonding surface is disposed at least in a region where a crease is formed to fold in a direction away from the animal excreta treatment sheet when the pet sheet is used by overlapping with the animal excreta treatment sheet. Accordingly, it is possible to store the pet sheet in a folded-in-quarters state, while preventing the region of the pet sheet from rolling up from the animal excreta treatment sheet when the pet sheet is opened from the folded-in-quarters state and used.

### (Aspect 14)

The pet sheet according to any one of Aspects 1 to 13, in which
a region along a second edge portion on a side opposite to a first edge portion along the folding line of the main body portion in the folded-in-half state has a color tone different from a region where the absorbent body is disposed when viewed from the top sheet side.

According to Aspect 14, when the pet sheet in the folded-in-half state is viewed from the outer side (top sheet side), the position of the opening (the edge portion on the side opposite to the folding line) can be visually and easily identified, and thus the convenience for the user can be improved.

### (Aspect 15)

The pet sheet according to Aspect 14, in which
a region excluding a region along the second edge portion in a region along a third edge portion connected to the first edge portion and intersecting the first edge portion has a same color tone as a region where the absorbent body is disposed when viewed from the top sheet side.

According to Aspect 15, while it is possible to easily identify the position of the opening by making the color tone of the region along the second edge portion a different color tone from the region where the absorbent body is disposed, by making the color tone of the region along the third edge portion the same color tone as the region where the absorbent body is disposed, it is possible to reduce the discomfort with respect to the pet sheet felt by pets trying to excrete on the animal excreta treatment sheet.

### (Aspect 16)

The pet sheet according to Aspect 14 or 15, in which
rigidity of a region along the second edge portion in the main body portion is lower than rigidity of a region where the absorbent body is disposed in the main body portion.

According to Aspect 16, the opening (the region along the second edge portion) formed with a color different from the region where the absorbent body is disposed can be visually and easily identified, and since the rigidity of the opening is lowered, the pet sheet in the folded-in-half state can be easily opened by gripping the opening with a hand.

### (Aspect 17)

The pet sheet according to any one of Aspects 1 to 16, in which
a proportion of cellulose fibers having a hydroxyl group in the absorbent body is 35% or less.

According to Aspect 17, the folding crease along the folding line generated in the main body portion can be reduced by making the main body portion be in a folded-in-half state. As a result, it is possible to reduce the discomfort given to the pet when the pet sheet is disposed on the animal excreta treatment sheet.

### (Aspect 18)

A pet sheet used by overlapping with a region where excreta is absorbed in an animal excreta treatment sheet that absorbs the excreta of animals, the pet sheet including
a main body portion including a liquid-permeable top sheet, a back sheet positioned on a side opposite to the top sheet, and an absorbent body disposed between the top sheet and the back sheet, in which
the back sheet has a back surface facing a side opposite to a side facing the top sheet,
a bonding surface to be bonded to the animal excreta treatment sheet is provided on the back surface in a state of being exposed to an outside,
a folding line that enables the main body portion to be folded in half is formed on the main body portion such that the back surface becomes an inner side,
the bonding surface is disposed such that, in a folded-in-half state folded in half along the folding line, a part of the bonding surface disposed in a first part of the main body portion positioned on one side with respect to the folding line faces a part of the bonding surface disposed in a second part of the main body portion positioned on an other side of the folding line, and
an edge portion of the main body portion parallel to the folding line is formed by a flap portion where the absorbent body is not provided.

As in Aspect 18, by forming the edge portion (that is, the edge portion of the main body portion positioned on the side opposite to the folding line in the folded-in-half state) of the main body portion parallel to the folding line with the flap portion having low rigidity, the edge portion can be easily gripped by hand, and the pet sheet in the folded-in-half state can be easily opened. Note that Aspect 18 can be combined with the configuration of Aspects 1 to 17 in any manner.

### (Aspect 19)

A package accommodating a plurality of pet sheets used by overlapping with a region where excreta is absorbed in an animal excreta treatment sheet which absorbs the excreta of animals, in which
the pet sheet includes:
a liquid-permeable top sheet;
a back sheet positioned on a side opposite to the top sheet; and
an absorbent body disposed between the top sheet and the back sheet,
the back sheet has a back surface facing a side opposite to a side facing the top sheet,
a bonding surface to be bonded to the animal excreta treatment sheet is provided on the back surface, and
the plurality of pet sheets accommodated in the package are arranged such that the top sheets of the adjacent pet sheets are in surface contact with each other in a folded state where each of the back surfaces becomes an inner side.

When the bonding surface of one pet sheet accommodated in the package comes into contact with the adjacent pet sheet, when the one pet sheet is pulled out, the bonding surface of the one pet sheet (or the cover sheet or the like covering the bonding surface) rubs against (or sticks to) the adjacent pet sheet, which may cause a problem that the one pet sheet cannot be appropriately pulled out. According to Aspect 19, by arranging and accommodating the plurality of pet sheets such that the top sheets of the adjacent pet sheets are in surface contact with each other, it is possible to realize a configuration in which the bonding surface of one pet sheet is less likely to come into contact with the adjacent pet sheet, and thus the above-described problem can be avoided.

### (Aspect 20)

The package according to Aspect 19, in which
the bonding surface of the pet sheet is not exposed to an outside in the folded state.

According to Aspect 20, since it is possible to reliably prevent the bonding surface of one pet sheet accommodated in the package from coming into contact with the adjacent pet sheet, it is possible to appropriately and easily pull out one pet sheet from the package.

### (Aspect 21)

The package according to Aspect 20, in which at least a part of the back surface of the pet sheet is exposed to the outside in the folded state.

According to Aspect 21, the following additional effects can be obtained together with the effect of Aspect 20 described above due to the bonding surface not being exposed to the outside. That is, after the pet sheet is taken out from the package, a part of the back surface exposed to the outside in the folded state in the pet sheet functions as a knob part, and thus the pet sheet can be easily unfolded from the folded-in-half state.

### Embodiment

Hereinafter, embodiments of the present disclosure will be described in detail with reference to the drawings. In the following description, the same or equivalent elements will be given the same reference numerals, and redundant description thereof will be omitted.

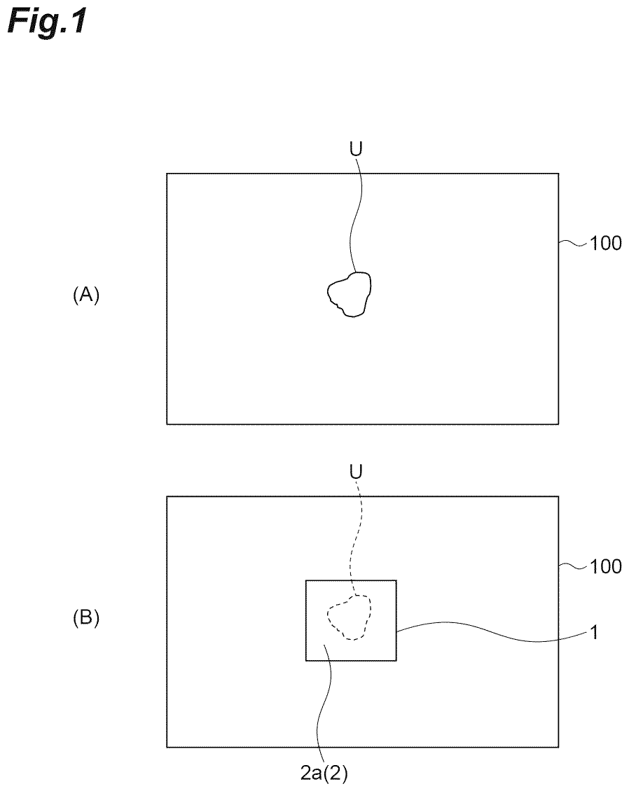

A configuration of a pet sheet 1 according to an embodiment will be described with reference to FIGS. 1 to 8. First, a usage example of the pet sheet 1 will be described with reference to FIG. 1. (A) of FIG. 1 shows a state after the animal excretes excreta U on an animal excreta treatment sheet (hereinafter referred to as a “treatment sheet”.) 100 that absorbs the excreta of animals (that is, a state where the excreta U is absorbed in a part of the treatment sheet 100). As an example, the treatment sheet 100 includes a liquid-permeable top sheet, a liquid-impermeable back sheet, and an absorbent body disposed between the top sheet and the back sheet, and is formed in a rectangular shape in plan view. The treatment sheet 100 is used for absorbing and retaining excreta excreted from an animal such as a pet and keeping a pet breeding space clean. The treatment sheet 100 is placed at a predetermined position in a pet breeding space (for example, in a room or the like) in an unfolded state. The treatment sheet 100 may be directly placed on the floor surface or the ground of the breeding space, or may be placed via a predetermined holder, tray, mat, or the like.

The animal to which the treatment sheet 100 is applied is, for example, an animal kept as a pet (hereinafter simply referred to as “pet”.). The pet to which the treatment sheet 100 is applied may be a mammal such as a dog, a cat, or a hamster, or may be an organism other than a mammal such as a bird, a reptile, or an amphibian.

The excreta U absorbed by the treatment sheet 100 is not particularly limited as long as the excreta U can be absorbed by the absorbent body included in the treatment sheet 100. Examples of the excreta U include liquid or low-viscosity feces, urine, saliva, blood, and other body fluids.

Pets tend to excrete while avoiding excreta traces (for example, urine traces) on the treatment sheet 100. For this reason, a problem may occur in which pets urinate in an abnormal urination posture in an attempt to avoid urine traces, resulting in urination outside the treatment sheet 100. In addition, in order to avoid such a problem, it is not appropriate from the viewpoint of environmental protection to replace the treatment sheet 100 with a new sheet even though there is still a usable margin region (region capable of absorbing new urine), and the user (for example, an owner of a pet) may feel guilt.

The pet sheet 1 is used to solve the above problems. That is, as shown in (B) of FIG. 1, the pet sheet 1 is used by overlapping with a region (for example, urine trace) of the treatment sheet 100 in which the excreta U is absorbed. As a result, the urine trace on the treatment sheet 100 can be hidden, and the use of the treatment sheet 100 can be continued while avoiding the problem that the pet urinates outside the treatment sheet 100 in order to avoid the urine trace. As a result, it becomes possible to use a single treatment sheet 100 for a longer period than before, thereby achieving improvements from the viewpoint of both environmental protection and user mental well-being.

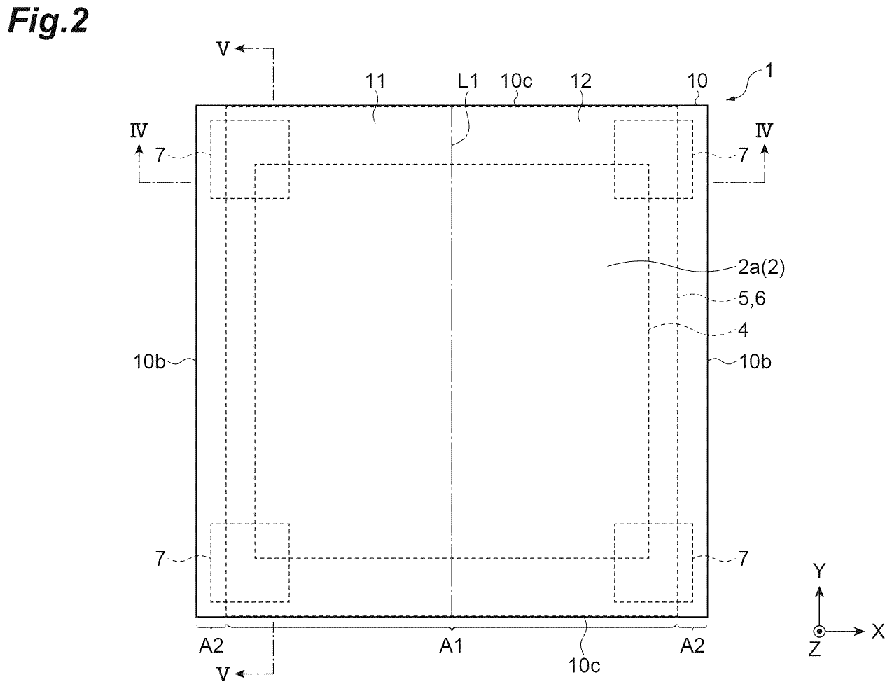

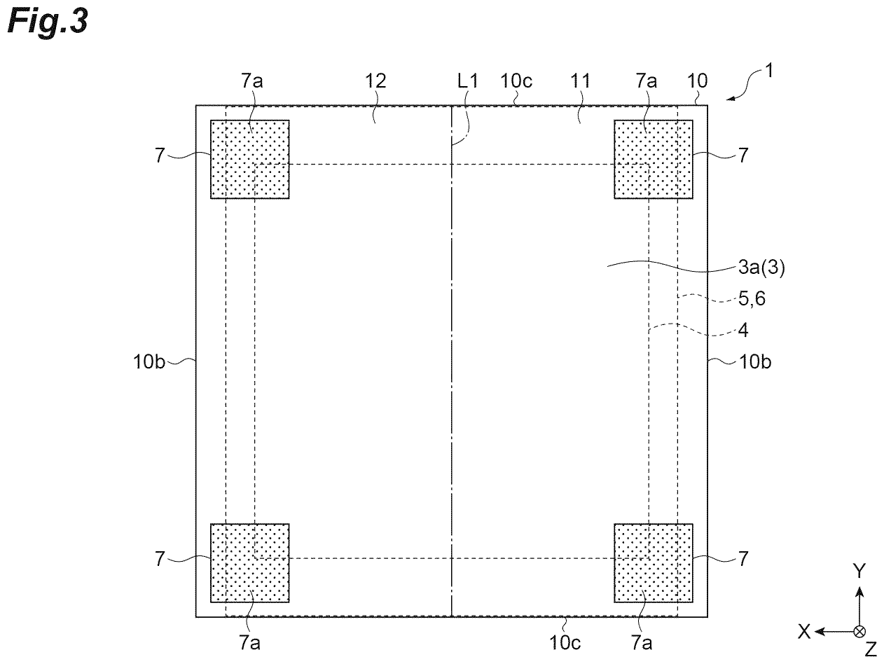

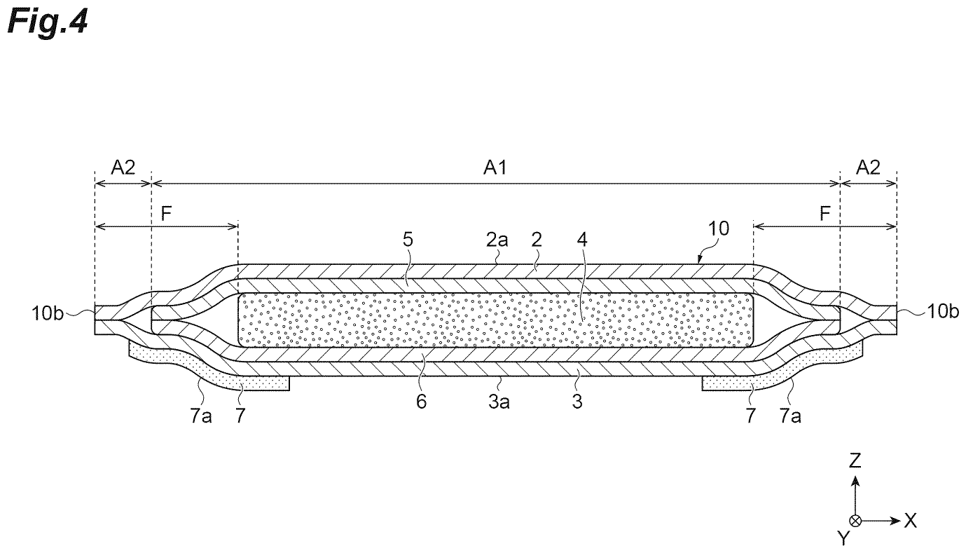

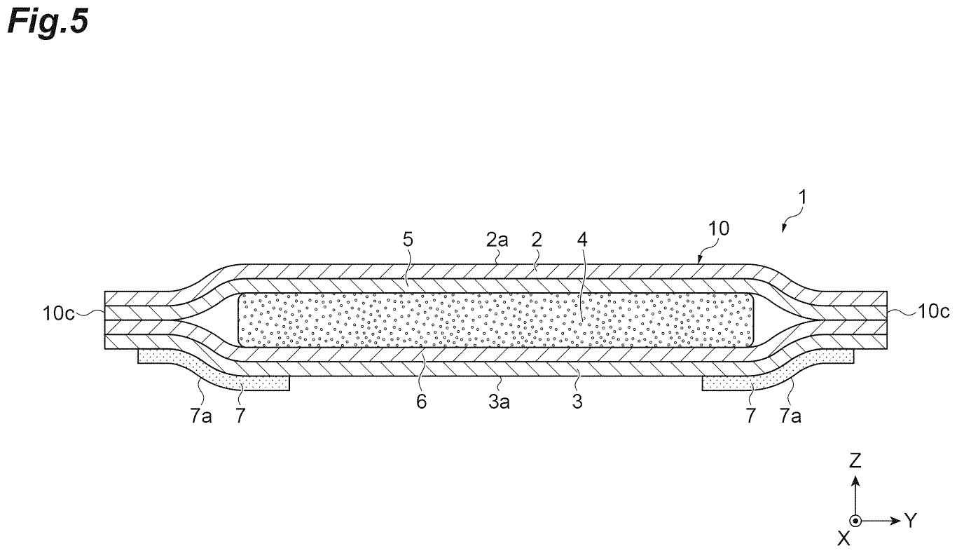

An example of a structure of the pet sheet 1 will be described with reference to FIGS. 2 to 5. FIG. 2 is a plan view of the pet sheet 1 as viewed from a front surface 2a side of a top sheet 2. FIG. 3 is a plan view of the pet sheet 1 as viewed from a back surface 3a side of a back sheet 3. FIG. 4 is a schematic view of a cross-sectional structure of the pet sheet 1 taken along line IV-IV in FIG. 2. FIG. 5 is a schematic view of a cross-sectional structure of the pet sheet 1 taken along line V-V in FIG. 2. In the present specification, for convenience, a thickness direction of the pet sheet 1 is represented as a Z-axis direction, a direction parallel to a folding line L1 of the pet sheet 1 to be described later is represented as a Y-axis direction, and a direction orthogonal to both the Z-axis direction and the Y-axis direction (that is, in a direction orthogonal to the folding line L1 when viewed from the Z-axis direction) is represented as an X-axis direction.

As shown in FIGS. 2 and 3, the pet sheet 1 includes a main body portion 10 formed in a rectangular shape in plan view. However, the shape of the main body portion 10 in a plan view is not limited to a rectangular shape, and any shape such as a polygon, a circle, or an ellipse can be adopted. The size of the main body portion 10 can be appropriately set according to the size, type, and the like of the pet to which the pet sheet 1 is used. The main body portion 10 includes the top sheet 2, the back sheet 3, and an absorbent body 4.

The top sheet 2 is formed of a sheet member having liquid permeability. The top sheet 2 is disposed on a side that receives pet excreta when the pet sheet 1 is used (that is, a case where the pet sheet 1 is placed on the treatment sheet 100). That is, the top sheet 2 is disposed on the side opposite to the side facing the treatment sheet 100 when the pet sheet 1 is used, and has the front surface 2a exposed to the outer side (upper side). The top sheet 2 is formed of a sheet member having liquid permeability such that excreta received by the front surface 2a can be moved to the back sheet 3 side. As an example, the sheet member constituting the top sheet 2 is formed of white fibers. Examples of such a sheet member include nonwoven fabrics such as an air-through nonwoven fabric, a spunbond nonwoven fabric, and a point-bonded nonwoven fabric. The nonwoven fabric constituting the top sheet 2 may be subjected to a hydrophilization treatment with a surfactant. The top sheet of the treatment sheet 100 may also be formed of a sheet member formed of a nonwoven fabric similar to the top sheet 2 of the pet sheet 1.

The back sheet 3 is a sheet positioned on a side opposite to the top sheet 2 in the Z-axis direction. As an example, the back sheet 3 is formed in a rectangular shape similar to the top sheet 2 to completely overlap with the top sheet 2 when viewed from the Z-axis direction. The back sheet 3 is disposed on a side facing the treatment sheet 100 when the pet sheet 1 is used, and has the back surface 3a facing the treatment sheet 100. As an example, the back sheet 3 may be formed of a liquid-impermeable sheet member. Examples of the sheet member constituting the back sheet 3 include a non-breathable resin film such as polyethylene and polypropylene, a laminate obtained by bonding a nonwoven fabric to the resin film, and a water-repellent or hydrophobic nonwoven fabric. When the back sheet 3 is formed of a liquid-impermeable sheet-like member as described above, it is possible to prevent excreta excreted on the pet sheet 1 from leaking to the treatment sheet 100 side. However, as described above, since the treatment sheet 100 itself includes the liquid-impermeable back sheet for preventing leakage of excreta, there is no major problem even when excreta excreted on the pet sheet 1 leaks to the treatment sheet 100 side. Therefore, the back sheet 3 may be formed of a liquid-permeable sheet member. In the present embodiment, the back surface 3a is formed of a material that is not bonded to a bonding surface 7a to be described later.

The absorbent body 4 is disposed between the top sheet 2 and the back sheet 3. That is, the absorbent body 4 is disposed on the side opposite to the front surface 2a side of the top sheet 2 and is disposed on the side opposite to the back surface 3a side of the back sheet 3. As an example, the absorbent body 4 is formed in a rectangular shape slightly smaller than the main body portion 10 (the top sheet 2 and the back sheet 3) when viewed from the Z-axis direction, and is disposed in a central portion of the main body portion 10 excluding a peripheral edge portion. As an example, the absorbent body 4 is formed of an absorbent core made of an absorbent material for absorbing and retaining excreta. The absorbent body 4 may be formed of a granular absorbent polymer. The absorbent polymer constituting the absorbent body 4 may be any polymer that can absorb and retain liquid, and for example, any super absorbent polymer such as polyacrylic acid-based, starch-based, or cellulose-based polymer can be adopted. As an example, the absorbent body 4 has a white color in a state before use (that is, a state where excreta is not absorbed and retained). Note that the configuration of the absorbent body 4 is not limited to the above. For example, the absorbent body 4 may be formed by a combination of an absorbent core and a core wrap covering the absorbent core.

As an example, the absorbent body 4 is disposed between the two intermediate sheets 5 and 6, and is sandwiched between the intermediate sheets 5 and 6. The intermediate sheet 5 is disposed between the top sheet 2 and the absorbent body 4. The intermediate sheet 6 is disposed between the back sheet 3 and the absorbent body 4. In the present embodiment, the intermediate sheets 5 and 6 function as a core wrap that prevents the absorbent body 4 from losing shape or the like.

As an example, the intermediate sheets 5 and 6 are formed in rectangular shapes having the same size when viewed from the Z-axis direction. The widths of the intermediate sheets 5 and 6 in the Y-axis direction are the same as the width of the main body portion 10 (the top sheet 2 and the back sheet 3) in the Y-axis direction. On the other hand, the widths of the intermediate sheets 5 and 6 in the X-axis direction are shorter than the width of the main body portion 10 (the top sheet 2 and the back sheet 3) in the X-axis direction. The intermediate sheets 5 and 6 are disposed at a central portion excluding a peripheral edge portion of the main body portion 10 in the X-axis direction. Accordingly, as shown in FIGS. 2, 3, and 4, the main body portion 10 is divided into a region A1 (first region) where the intermediate sheets 5 and 6 are disposed at a central portion of the main body portion 10 in the X-axis direction and a region A2 (second region) where the intermediate sheets 5 and 6 are not disposed at both end portions of the main body portion 10 in the X-axis direction.

As an example, the intermediate sheet 5 is formed of tissue colored in a color other than white (for example, blue). On the other hand, the intermediate sheet 6 is formed of white tissue. The top sheet 2, the back sheet 3, and the intermediate sheet 6 have a predetermined or higher visible light transmittance. Therefore, when the pet sheet 1 is viewed from the front surface 2a side, the blue color of the intermediate sheet 5 is visually recognized in the region A1, and the white color of the top sheet 2 is visually recognized in the region A2. On the other hand, when the pet sheet 1 is viewed from the back surface 3a side, the white color of the absorbent body 4 is visually recognized in a region where the absorbent body 4 is disposed in the region A1, the blue color of the intermediate sheet 5 is visually recognized in a region where the absorbent body 4 is not disposed in the region A1, and the white color of the top sheet 2 is visually recognized in the region A2. As described above, the color tone of the pet sheet 1 is different between the case of being viewed from the front surface 2a side and the case of being viewed from the back surface 3a side. As a result, the user of the pet sheet 1 can easily identify the front and back surfaces of the pet sheet 1 from the color tone of the pet sheet 1.

As shown in FIGS. 3 to 5, the back surface 3a of the back sheet 3 is provided with a bonding portion 7 having the bonding surface 7a bonded to the treatment sheet 100. The bonding portion 7 is provided in a state where the bonding surface 7a is exposed to the outside. That is, in a state before use of the pet sheet 1 or the like, a member such as a cover sheet that covers the bonding surface 7a is not provided. As an example, four rectangular bonding portions 7 are provided at corner portions (four corners) of the back surface 3a. In the present embodiment, each bonding portion 7 is disposed such that the outer edge portion of each bonding portion 7 is separated from the outer edge portion of the back surface 3a. However, each bonding portion 7 may be disposed such that the outer edge portion of each bonding portion 7 coincides with the outer edge portion of the back surface 3a.

In the main body portion 10, a folding line L1 for folding the main body portion 10 in half is formed such that the back surface 3a becomes an inner side. As an example, the folding line L1 passes through a center position of the main body portion 10 in the X-axis direction and extends along a direction (Y-axis direction) orthogonal to the X-axis direction.

The folding line L1 can be formed by, for example, a folding crease formed in the main body portion 10 in advance. As shown in FIGS. 1 and 2, the main body portion 10 is divided into a first part 11 positioned on one side (as an example, the left side in FIG. 2) with respect to the folding line L1 and a second part 12 positioned on the other side (as an example, the right side in FIG. 2) with respect to the folding line L1. Since the first part 11 and the second part 12 are symmetric, the first part 11 and the second part 12 may be reversed. That is, the first part 11 may be regarded as the “second part”, and the second part 12 may be regarded as the “first part”.

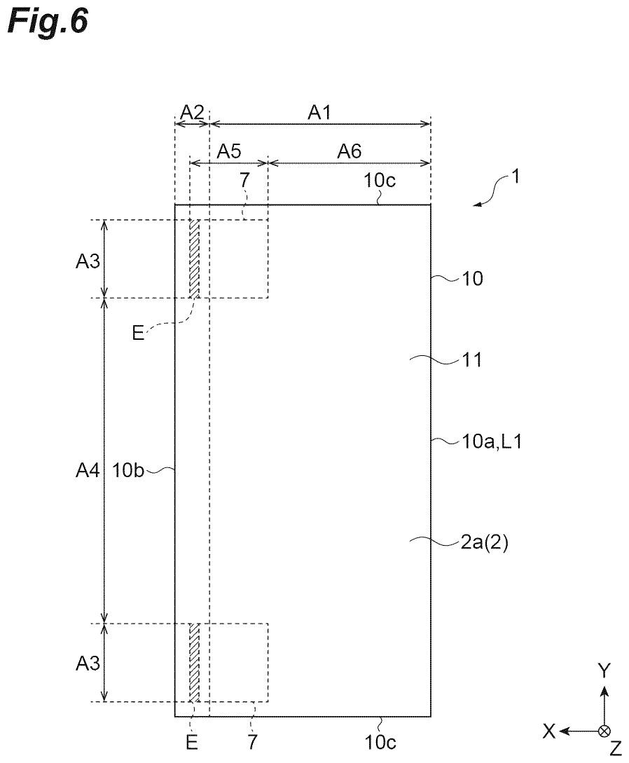

FIG. 6 shows the main body portion 10 in a folded-in-half state folded in half such that the back surface 3a becomes the inner side along the folding line L1. More specifically, FIG. 6 is a plan view of the main body portion 10 in a folded-in-half state as viewed from a side facing the front surface 2a of the first part 11. As shown in FIG. 6, the pet sheet 1 can be stored compactly by being in the folded-in-half state in a state before use or the like.

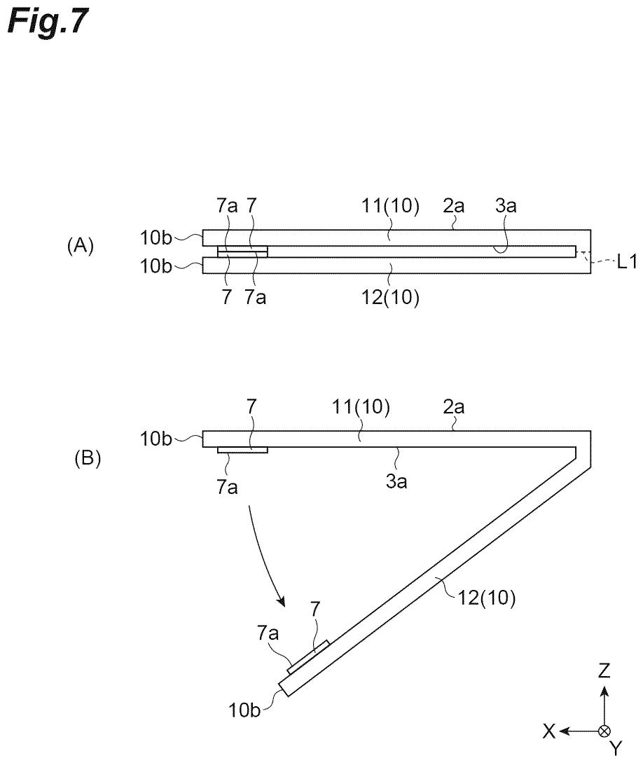

FIG. 7 is a schematic view of the pet sheet 1 transitioning from the folded-in-half state to the unfolded state as viewed from the side (direction along the folding line L1 (Y-axis direction)). The bonding surface 7a (in the present embodiment, the bonding surface 7a of each of the four bonding portions 7) provided on the pet sheet 1 is configured such that, in a case where only the first part 11 of the main body portion 10 in the folded-in-half state is retained such that the first part 11 is positioned above the second part 12 as shown in (A) of FIG. 7, the second part 12 is naturally separated from the first part 11 and the folded-in-half state is released as shown in (B) of FIG. 7. Hereinafter, the function of naturally releasing and unfolding the folded-in-half state in this manner is referred to as an “unfolding function”. Since the pet sheet 1 has the above-described unfolding function, the pet sheet 1 can be easily changed from the folded-in-half state to the unfolded state (opened state), and thus the convenience of the user who uses the pet sheet 1 can be improved.

In the present embodiment, the four bonding portions 7 are disposed to be line-symmetric with respect to the folding line L1. Specifically, in the folded-in-half state, the two bonding portions 7 provided in the first part 11 are disposed to face (overlap) the two bonding portions 7 provided in the second part 12. Therefore, in the case of being in the folded-in-half state, there is a possibility that the bonding surface 7a provided on the first part 11 and the bonding surface 7a provided on the second part 12 come into contact with each other and are bonded to each other. Here, when the bonding surface 7a of the first part 11 and the bonding surface 7a of the second part 12 are firmly bonded, the unfolding function is not exhibited, and it is necessary to separate the bonding surfaces 7a with a strong force in order to change the pet sheet 1 from the folded-in-half state into the unfolded state, which takes time and effort of the user. Therefore, in the present embodiment, in order to exhibit the above-described unfolding function, the bonding strength between the bonding surfaces 7a facing each other in the folded-in-half state is set such that the second part 12 is separated from the first part 11 by its own weight of the second part 12 and the folded-in-half state is released in a case where only the first part 11 of the main body portion 10 in the folded-in-half state is retained such that the first part 11 is positioned above the second part 12. Hereinafter, the function of releasing and unfolding the folded-in-half state by its own weight of the second part 12 in this manner is referred to as an “own weight unfolding function”.

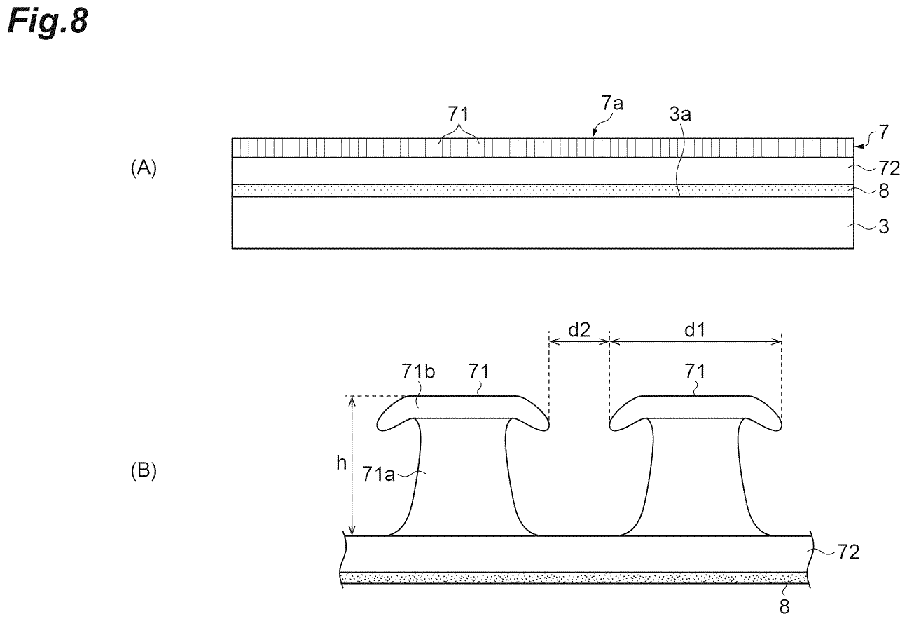

(A) of FIG. 8 is a schematic view showing a structure example of the bonding portion 7 provided on the back surface 3a of the pet sheet 1. (B) of FIG. 8 is a partially enlarged view of the bonding portion 7. As shown in FIG. 8, as an example, the bonding portion 7 includes a plurality of hooks 71 and a flat hook sheet 72 that supports and fixes the plurality of hooks 71. By fixing the hook sheet 72 to the back surface 3a via an adhesive layer 8, the bonding portion 7 is fixed to the back surface 3a. The bonding surface 7a of the bonding portion 7 is formed of a front surface (hook surface) of the hook sheet 72 provided with the plurality of hooks 71. In this case, the setting of the bonding strength between the bonding surfaces 7a for exhibiting the above-described own weight unfolding function can be realized by adjusting the shape, height, density (number of hooks in unit region, distance between hooks, and the like), and the like of the plurality of hooks 71, the contact area between the bonding surfaces 7a facing (contacting) each other in the folded-in-half state, and the like.

As shown in (B) of FIG. 8, as an example, each hook 71 may be formed by a columnar portion 71a and an umbrella portion 71b. The columnar portion 71a is a columnar part erected from the hook sheet 72. The umbrella portion 71b is provided at the tip of the columnar portion 71a and is a part having a hook diameter d1 larger than the diameter of the columnar portion 71a. When the pet sheet 1 is placed on the treatment sheet 100 as shown in (B) of FIG. 1, the umbrella portion 71b of each hook 71 enters the space between the nonwoven fabrics constituting the top sheet of the treatment sheet 100 and is engaged with the top sheet. As a result, the pet sheet 1 is bonded (engaged) to the treatment sheet 100 via the bonding portion 7.

As an example, the height h of the hook 71 is 45 μm to 350 μm. By setting the height h of the hook 71 within the above range and suppressing the bonding strength of the hook 71 to a certain value or less, it is possible to suitably realize a configuration in which the main body portion 10 is easily opened from the folded-in-half state while allowing the pet sheet 1 to be bonded to the treatment sheet 100. The height h of the hook 71 may be set to 45 μm to 150 μm. In this case, by further suppressing the height h of the hook 71, when the pet sheet 1 is bonded to the treatment sheet 100, it is possible to suppress the swelling of the pet sheet 1 at the bonding portion 7 and to reduce the discomfort given to the pet. A distance d2 between the adjacent hooks 71 is set in a range of 70 μm to 410 μm, for example. More preferably, the distance d2 between the adjacent hooks 71 is set in the range of 120 μm to 300 μm. As described above, in order to exhibit the above-described own weight unfolding function, other parameters (for example, the distance between the hooks) may be adjusted together with the height h of the hook 71.

### [Operation and Effect of Present Embodiment]

In the pet sheet 1, on the back surface 3a, the bonding surface 7a bonded to the treatment sheet 100 is provided in a state of being exposed to the outside. Further, in the main body portion 10, the folding line L1 for folding the main body portion 10 in half is formed such that the back surface 3a becomes an inner side. In addition, the pet sheet 1 has the above-described unfolding function. As described above, the bonding surface 7a provided on the back surface 3a of the pet sheet 1 is exposed to the outside, a cover sheet (release paper or the like) or the like covering the bonding surface 7a is not provided, and thus the time and effort of peeling off the cover sheet is not required when the pet sheet 1 is used. In addition, in this case, as described in the present embodiment, there is a concern that the bonding surfaces 7a face (contact) each other in the folded-in-half state and are bonded to each other. However, since the bonding surfaces 7a are configured to have the unfolding function, the user can release the folded-in-half state only by holding the pet sheet 1 with one hand without applying any special force when using the pet sheet 1 in the folded-in-half state, and can make the pet sheet 1 attachable to the treatment sheet 100. Accordingly, according to the pet sheet 1, the time and effort of the user at the time of using the pet sheet 1 can be effectively reduced, and the use of the pet sheet 1 can be promoted.

In addition, in the pet sheet 1, the bonding surface 7a is disposed such that at least a part of the bonding surface 7a disposed in the first part 11 and a part of the bonding surface 7a disposed in the second part 12 face each other in the folded-in-half state. In addition, in the present embodiment, as an example, the bonding surfaces 7a are disposed line-symmetrically with respect to the folding line L1, and accordingly, each bonding surface 7a is disposed such that all the bonding surfaces 7a (two bonding surfaces 7a) disposed in the first part 11 and all the bonding surfaces 7a (two bonding surfaces 7a) disposed in the second part 12 completely overlap with each other. After each of the bonding surfaces 7a is disposed in this manner, the pet sheet 1 has the above-described own weight unfolding function. That is, the bonding strength of each bonding surface 7a is adjusted to exhibit the own weight unfolding function. By setting the bonding strength between the bonding surfaces 7a such that the folded-in-half state is released by its own weight of the second part 12, it is possible to realize a configuration that achieves the above-described effect (that is, the effect of reducing the time and effect of the user at the time of using the pet sheet 1) while making it possible to dispose the bonding surfaces 7a such that the bonding surfaces 7a are in contact with each other in the folded-in-half state (that is, while securing the degree of freedom in the arrangement of the bonding surfaces 7a).

Whether the pet sheet 1 has the above-described own weight unfolding function can be confirmed by an own weight unfolding test as described below.

### <One Example of Own Weight Unfolding Test>

1. As shown in (A) of FIG. 7, the pet sheet 1 in the folded-in-half state where the main body portion 10 is folded in half such that the first part 11 is positioned above the second part 12 is placed on a horizontal plane (for example, a horizontal floor surface or the like).
2. Only the first part 11 is retained without retaining the second part 12 by a predetermined tool or a human hand, and the pet sheet 1 is pulled upward while maintaining the posture in which the first part 11 is substantially parallel to the horizontal plane.
3. In a case where the second part 12 is separated downward from the first part 11 as shown in (B) of FIG. 7 within a predetermined time (for example, 10 seconds or the like) after the operation of “2.” described above is performed, it is determined that the above-described own weight unfolding function is provided.

In the operation “2.” described above, a method for retaining only the first part 11 while making the first part 11 substantially parallel to the horizontal plane is not particularly limited. For example, the first part 11 may be retained by sucking the front surface 2a of the first part 11 with a predetermined tool, or the first part 11 may be retained by gripping an edge portion (for example, edge portions 10c on both sides facing each other in the Y-axis direction) of the first part 11 with a human finger.

In addition, as shown in FIG. 6, in a region along an edge portion 10b (second edge portion) on a side opposite to an edge portion 10a (first edge portion) along the folding line L1 of the main body portion 10 in the folded-in-half state, a length along the edge portion 10b of a bonding region A3 provided with the bonding surface 7a (bonding portion 7) is shorter than a length along the edge portion 10b of a non-bonding region A4 which is not provided with the bonding surface 7a. In the present embodiment, edge portions (that is, edge portions overlapping with each other in the folded-in-half state) on both sides in the X-axis direction in the unfolded state (refer to FIGS. 2 and 3) form the edge portion 10b. In the present embodiment, since the bonding portions 7 are provided at the four corners of the back surface 3a, the bonding regions A3 are formed in the vicinity of the end portions on both sides in the Y-axis direction, and one non-bonding region A4 is formed between the two bonding regions A3. That is, in the present embodiment, the length in the Y-axis direction of the combined region of the two bonding regions A3 is shorter than the length in the Y-axis direction of one non-bonding region A4. According to the above configuration, since the length in the Y-axis direction of the non-bonding region A4 can be sufficiently secured, in the non-bonding region A4 of the region along the edge portion 10b, it is possible to realize a structure in which a finger can be easily inserted into the inner side (between the first part 11 and the second part 12) of the main body portion 10 in the folded-in-half state. As a result, it is easy to release the folded-in-half state into a state where the pet sheet 1 can be attached to the treatment sheet 100.

In addition, as shown in FIG. 6, in a region along an edge portion 10c (third edge portion) connected to the edge portion 10a and intersecting the edge portion 10a along the folding line L1 of the main body portion 10 in the folded-in-half state, a length along the edge portion 10c of a bonding region A5 provided with the bonding surface 7a (bonding portion 7) is shorter than a length along the edge portion 10c of a non-bonding region A6 which is not provided with the bonding surface 7a. In the present embodiment, the edge portions on both sides in the Y-axis direction in the unfolded state (refer to FIGS. 2 and 3) form the edge portion 10c. In addition, in the present embodiment, since the bonding portions 7 are provided at the four corners of the back surface 3a, the bonding region A5 is formed in the vicinity of the edge portions 10b in the X-axis direction, and the non-bonding region A6 is formed closer to the edge portion 10a than the bonding region A5. That is, in the present embodiment, the length in the X-axis direction of one bonding region A5 is shorter than the length in the X-axis direction of one non-bonding region A6. According to the above configuration, since the length in the X-axis direction of the non-bonding region A6 can be sufficiently secured, in the non-bonding region A6 of the region along the edge portion 10c, it is possible to realize a structure in which a finger can be easily inserted into the inner side (between the first part 11 and the second part 12) of the main body portion 10 in the folded-in-half state. As a result, it is easy to release the folded-in-half state into a state where the pet sheet 1 can be attached to the treatment sheet 100.

As shown in FIG. 3, the bonding surface 7a is disposed not to overlap with the folding line L1. According to the above configuration, since the bonding surface 7a is not deformed (not folded) even when the main body portion 10 is in a folded-in-half state, the parallel state of the bonding surface 7a can be appropriately maintained. As a result, it is possible to avoid the bonding function of the bonding surface 7a with respect to the treatment sheet 100 from being impaired by being in the folded-in-half state. In addition, when the bonding surface 7a overlaps with the folding line L1, in a case where the bonding surface 7a (bonding portion 7) is formed of a member having relatively high rigidity, it becomes difficult to fold the main body portion 10 in half along the folding line L1. According to the above configuration, such a problem can also be avoided.

In addition, as shown in FIG. 8, the bonding surface 7a is formed of a hook surface (the front surface of the hook sheet 72) provided with a plurality of hooks 71. That is, the bonding surface 7a is not formed of, for example, an adhesive surface such as HMA. According to the above configuration, it is possible to easily realize a configuration in which the bonding surface 7a is exposed to the outside (that is, a configuration in which it is unnecessary to cover the bonding surface 7a with a cover sheet such as a release paper in a state before use of the pet sheet 1).

In addition, as shown in FIG. 6, the region (in the present embodiment, the region A2 where the absorbent body 4 is not disposed) along the edge portion 10b of the main body portion 10 in the folded-in-half state has a color tone different from the region where the absorbent body 4 is disposed when viewed from the top sheet 2 side. In the present embodiment, as described above, the region A2 along the edge portion 10b is visually recognized as white (color of the top sheet 2) when viewed from the front surface 2a side. On the other hand, the region A1 including the region where the absorbent body 4 is disposed is visually recognized as blue (the color of the intermediate sheet 5). According to the above configuration, when the pet sheet 1 in the folded-in-half state is viewed from the outer side (top sheet 2 side), the position of the opening (the edge portion 10b on the side opposite to the folding line L1) can be visually and easily identified, and thus the convenience for the user can be improved.

In addition, the region (that is, the region along the edge portion 10c in the region A1) excluding the region A2 along the edge portion 10b in the region (that is, the region along both end portions in the Y-axis direction of the main body portion 10) along the edge portion 10c has the same color tone as the region where the absorbent body 4 is disposed when viewed from the top sheet 2 side. In the present embodiment, as described above, when the pet sheet 1 is viewed from the front surface 2a side, the entire region A1 is visually recognized as blue (the color of the intermediate sheet 5) regardless of whether the absorbent body 4 is disposed. According to the above configuration, while it is possible to easily identify the position of the opening by making the color tone of the region A2 along the edge portion 10b a different color tone from the region (a part of the region A1) where the absorbent body 4 is disposed, by making the color tone of the region (that is, a region on the outer side of the region where the absorbent body 4 is disposed in the region A1) excluding the region A2 in the region along the edge portion 10c the same color tone as the region where the absorbent body 4 is disposed, it is possible to reduce the discomfort with respect to the pet sheet 1 felt by pets trying to excrete on the treatment sheet 100. In other words, by providing as few boundary portions as possible where the color tone changes, the occurrence of discomfort caused by color tone changes can be suppressed. In addition, in a case where the color tone (color tone when viewed from the top sheet side) of the top sheet of the treatment sheet 100 is set to the same color tone (blue in the present embodiment) as the region of the pet sheet 1 where the absorbent body 4 is disposed, the boundary between the pet sheet 1 and the treatment sheet 100 can be made less noticeable in the region in the vicinity of the edge portion 10c of the pet sheet 1. As a result, it is possible to reduce the discomfort to the pet sheet 1 as described above.

In addition, the rigidity of the region (in the present embodiment, the region A2 where the absorbent body 4 is not disposed) along the edge portion 10b of the main body portion 10 is lower than the rigidity of the region (a part of the region A1) where the absorbent body 4 is disposed in the main body portion 10. That is, since the region where the absorbent body 4 is disposed is thicker than the region A2 by at least the absorbent body 4, the region has higher rigidity than the region A2. In other words, since the region A2 is thinner and softer than the central portion (the region where the absorbent body 4 is disposed) of the main body portion 10, the region A2 more easily rolls up when opened from the folded-in-half state. Therefore, according to the above configuration, the opening (the region along the second edge portion) formed with a color different from the region where the absorbent body 4 is disposed can be visually and easily identified, and since the rigidity of the opening is lowered, the pet sheet 1 in the folded-in-half state can be easily opened by gripping the opening with a hand.

In addition, a proportion of cellulose fibers having a hydroxyl group in the absorbent body 4 may be 35% or less. According to the above configuration, the folding crease along the folding line L1 generated in the main body portion 10 by making the main body portion 10 be in a folded-in-half state can be reduced. That is, it is possible to suppress the degree of the folding crease along the folding line L1 to such an extent that it is possible to specify the location to be folded when the pet sheet 1 is in the folded-in-half state, and to make the pet sheet 1 as unnoticeable and flat as possible when the pet sheet 1 is unfolded. As a result, it is possible to reduce the discomfort given to the pet when the pet sheet 1 is disposed on the treatment sheet 100.

As shown in FIG. 4, the edge portion 10b of the main body portion 10 parallel to the folding line L1 is formed by a flap portion F where the absorbent body 4 is not present. That is, the peripheral edge portion of the main body portion 10 has lower rigidity than the region where the absorbent body 4 is disposed. According to the above configuration, by forming the edge portion (that is, the edge portion 10b of the main body portion 10 positioned on the side opposite to the folding line L1 in the folded-in-half state) of the main body portion 10 parallel to the folding line L1 with the flap portion F having low rigidity, the edge portion 10b can be easily gripped by hand, and the pet sheet 1 in the folded-in-half state can be easily opened. Accordingly, the time and effort of the user at the time of using the pet sheet 1 can be effectively reduced, and the use of the pet sheet 1 can be promoted.

### Modification Example

Although the embodiments of the present disclosure have been described above, the present disclosure is not limited to the above embodiments. The material and shape of each configuration are not limited to the above-described material and shape, and various materials and shapes can be adopted. In addition, some configurations included in the configurations of the above-described embodiments may be changed or omitted, or other configurations may be added.

For example, in the above embodiment, the hook surface is exemplified as an example of the bonding surface 7a, but the bonding surface 7a may be formed by a surface other than the hook surface. For example, the bonding surface 7a may be an adhesive surface or a paste surface (for example, a surface to which glue similar to the back surface of the stamp is applied.).

In the above embodiment, the pet sheet 1 does not necessarily have the own weight unfolding function. Even in that case, since the flap portion F is formed as described above, the pet sheet 1 in the folded-in-half state can be opened relatively easily, and thus, it is possible to reduce the time and effort of the user.

### (Modification Example of Arrangement of Bonding Surface)

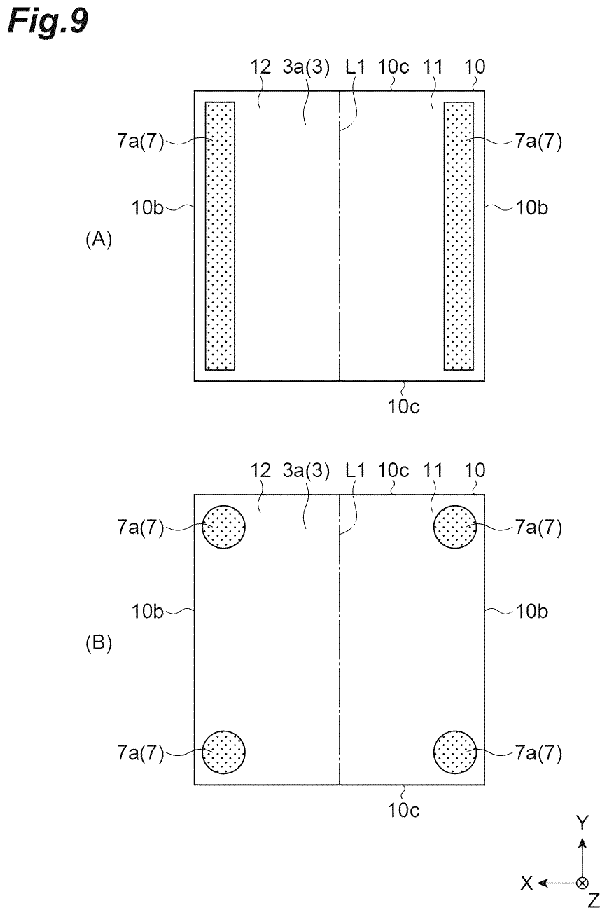

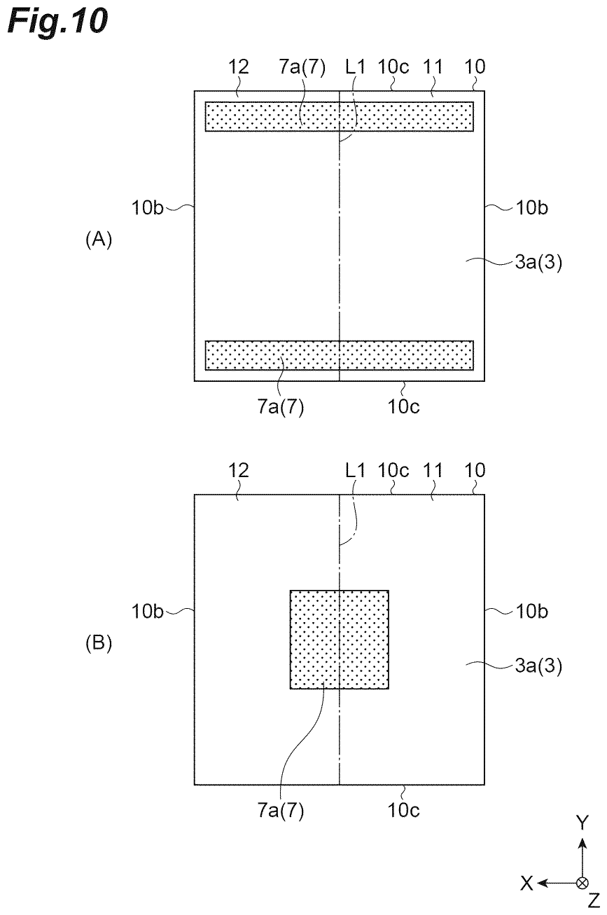

The shape and arrangement of the bonding surface 7a (bonding portion 7) are not limited to the above embodiment. For example, as a modification example of the configuration in which the bonding surface 7a is disposed line-symmetrically with respect to the folding line L1 as in the above-described embodiment, the configurations shown in FIGS. 9 and 10 can be exemplified. In the example of (A) of FIG. 9, two bonding surfaces 7a extending in a strip shape in the Y-axis direction are disposed along the edge portions (edge portions 10b) on both sides in the X-axis direction. In the example of (B) of FIG. 9, four bonding surfaces 7a formed in a shape (as an example, a circular shape) other than a rectangular shape are disposed at four corners of the back surface 3a. In addition, the bonding surface 7a may be disposed to overlap with the folding line L1 as long as the bonding surface 7a has flexibility enough to be bent along the folding line L1. In the example of (A) of FIG. 10, two bonding surfaces 7a extending in a strip shape in the X-axis direction are disposed along the edge portions (edge portions 10c) on both sides in the Y-axis direction. In the example of (B) of FIG. 10, one bonding surface 7a (in this example, the rectangular bonding surface 7a) is disposed at the central portion of the back surface 3a.

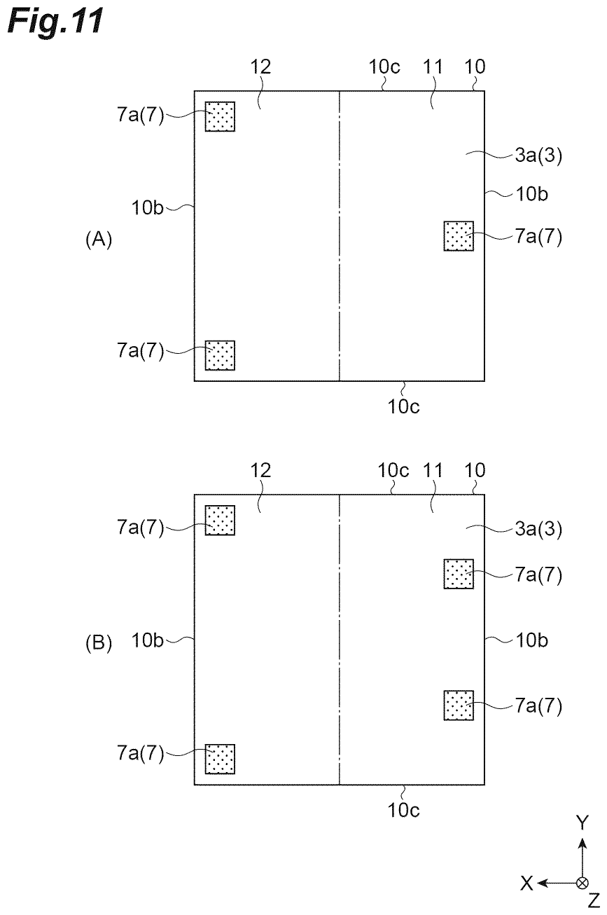

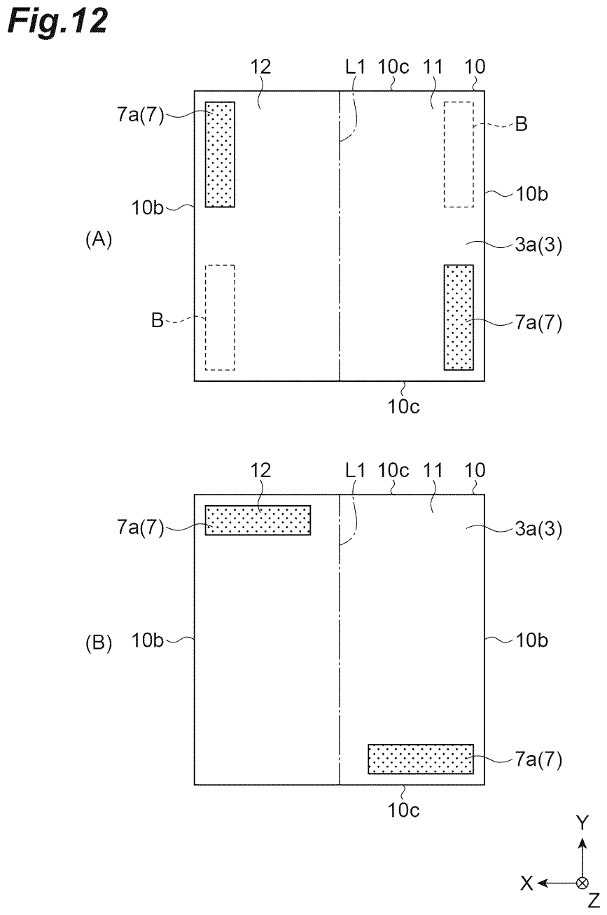

Further, the bonding surface 7a may be disposed on the back surface 3a such that the bonding surfaces 7a do not face each other in the folded-in-half state. For example, as shown in FIGS. 11 and 12, the bonding surface 7a may be disposed. In the example of (A) of FIG. 11, one bonding surface 7a is disposed at the central portion in the Y-axis direction of the part along the edge portion 10b of the first part 11. Further, two bonding surfaces 7a are disposed at parts along the edge portions (edge portions 10c) on both sides in the Y-axis direction of the part along the edge portion 10b of the second part 12. The example of (B) of FIG. 11 is different from the example of (A) of FIG. 11 in that two bonding surfaces 7a disposed apart from each other in the Y-axis direction are disposed at the central portion in the Y-axis direction of a part along the edge portion 10b of the first part 11. In the example of (A) of FIG. 12, the bonding surface 7a extending in the Y-axis direction is disposed in a region on one side (lower side in the drawing) in the Y-axis direction of a part along the edge portion 10b of the first part 11, and the bonding surface 7a extending in the Y-axis direction is disposed in a region on the other side (upper side in the drawing) in the Y-axis direction of a part along the edge portion 10b of the second part 12. In the example of (B) of FIG. 12, the bonding surface 7a extending in the X-axis direction is disposed in a part along the edge portion 10c on one side (lower side in the drawing) of the first part 11, and the bonding surface 7a extending in the X-axis direction is disposed in a part along the edge portion 10c on the other side (upper side in the drawing) of the second part 12.

According to the configuration in which the bonding surfaces 7a do not face (do not contact) each other in the folded-in-half state as shown in FIGS. 11 and 12, it is possible to prevent the bonding surfaces 7a from being bonded to each other in the folded-in-half state. Therefore, for example, by configuring the back surface 3a with a material that is difficult to be bonded to the bonding surface 7a, the above-described unfolding function can be suitably exhibited.

In addition, as in the examples of FIGS. 11 and 12, in a case where the back surface 3a is formed of the bonding surface 7a and the non-bonding surface (surface of the back surface 3a other than the bonding surface 7a) not provided with the bonding surface 7a, and at least a part of the non-bonding surface faces the bonding surface 7a in the folded-in-half state, a part of the non-bonding surface facing the bonding surface 7a at least in the folded-in-half state (for example, a part B indicated by a broken line in (A) of FIG. 12) may be formed by a film not engaged with the hook 71. According to the above configuration, since the bonding surfaces 7a (hooks 71) and the non-bonding surfaces (the part B formed of a film) facing each other in the folded-in-half state can be reliably prevented from being bonded (engaged), it is possible to suitably realize a configuration in which the main body portion 10 easily changes from the folded-in-half state to the unfolded state. That is, the above-described unfolding function can be reliably exhibited.

From the viewpoint of reliably preventing the bonding surface 7a from being bonded to the non-bonding surface, not only the part B of the non-bonding surface facing the bonding surface 7a in a folded-in-half state, but also the entire non-bonding surface is preferably formed of a film that does not engage with the hook 71. For example, the entire back surface 3a may be configured as a film surface that is not engaged with the hook 71.

In addition, in the above embodiment (FIGS. 1 to 8) and some modification examples (FIGS. 9 to 12), the aspect in which the bonding surfaces 7a completely overlap with each other in the folded-in-half state (FIGS. 1 to 10) and the aspect in which the bonding surfaces 7a do not overlap with each other at all in the folded-in-half state (FIGS. 11 and 12) have been exemplified, but an aspect in which the bonding surfaces 7a partially overlap with each other in the folded-in-half state may be adopted. That is, in the folded-in-half state, an aspect in which a part of the one bonding surface 7a overlaps with the other bonding surface 7a and the other part of the one bonding surface 7a overlaps with the non-bonding surface (the back surface 3a on which the bonding surface 7a is not provided) may be adopted. As described above, according to the configuration in which the bonding surfaces 7a facing each other in the folded-in-half state partially overlap with each other, the bonding strength between the bonding surfaces 7a can be weakened as compared with the configuration in which the bonding surfaces 7a facing each other in the folded-in-half state completely overlap with each other, and thus the above-described own weight unfolding function can be easily exhibited.

In addition, as shown in FIG. 6, the hook sheet 72 (bonding portion 7) may have a sheet edge portion E (in the example of FIG. 6, the edge portion along the edge portion 10b) along an edge portion (that is, the edge portion 10b or the edge portion 10c) different from the edge portion 10a along the folding line L1 of the main body portion 10 in the folded-in-half state, and the sheet edge portion E may not be bonded to the back surface 3a. That is, the adhesive layer 8 (refer to (A) of FIG. 8) may not be provided between the sheet edge portion E and the back surface 3a. According to the above configuration, since the back sheet 3 and the sheet edge portion E are separated from each other without adhering to each other, it is possible to realize a configuration in which the main body portion can be easily opened from the folded-in-half state. More specifically, when the pet sheet 1 is opened by gripping the part (for example, the flap portion F (refer to FIG. 4)) along the edge portion (in the example of FIG. 6, the edge portion 10b) of the main body portion 10 along which the sheet edge portion E extends, the flap portion F easily rolls up by the sheet edge portion E, and thus the pet sheet 1 in the folded-in-half state can be easily opened.

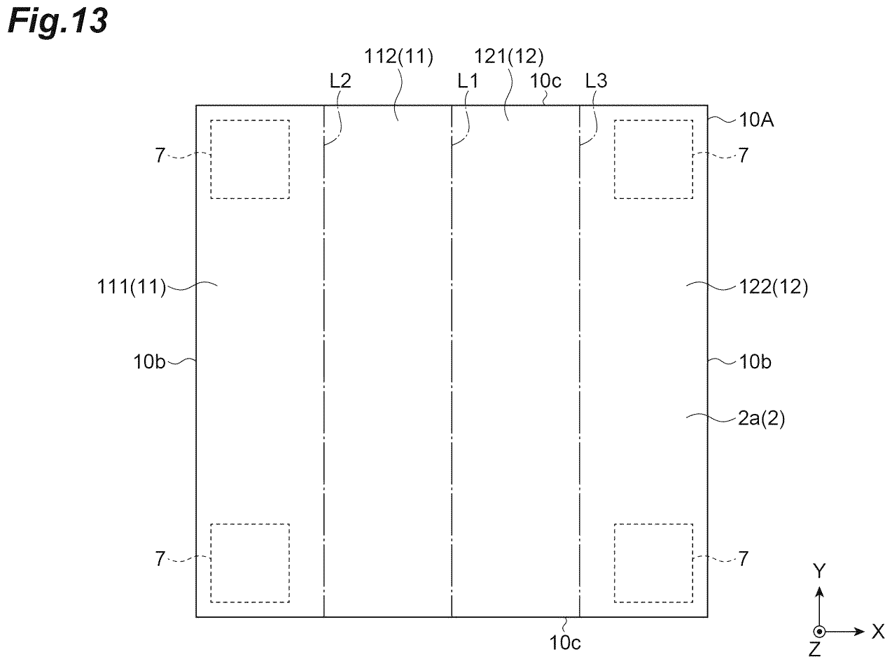

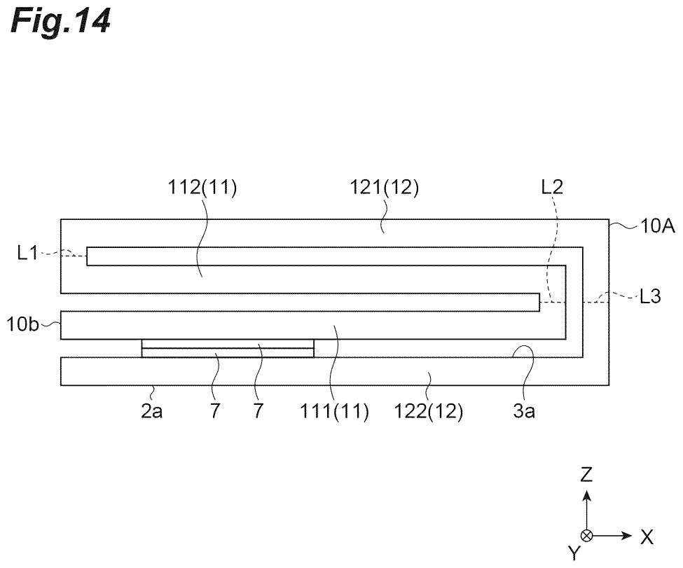

Furthermore, the main body portion 10 may be configured to be able to be in a folded-in-quarters state by further folding in half from the folded-in-half state. Hereinafter, a main body portion 10A as an example of the above configuration will be described with reference to FIGS. 13 and 14. FIG. 13 is a plan view of the main body portion 10A in the unfolded state as viewed from the front surface 2a side. FIG. 14 is a schematic view of the main body portion 10A in a folded-in-quarters state as viewed from the side surface.

As shown in FIGS. 13 and 14, in the main body portion 10A, a folding line L2 (second folding line, third folding line) is formed between the edge portion 10b of the first part 11 and the folding line L1. In addition, a folding line L3 (second folding line) is formed between the edge portion 10b of the second part 12 and the folding line L1. In other words, in the main body portion 10A, two folding lines L2 and L3 for further folding the pet sheet in half again from the folded-in-half state into a folded-in-quarters state are formed on both sides sandwiching the folding line L1.

In the main body portion 10A, the first part 11 is further divided into two parts (two parts overlapping with each other in the folded-in-quarters state) by the folding line L2. Specifically, the first part 11 is divided into a part 111 between the edge portion 10b of the first part 11 and the folding line L2 and a part 112 between the folding line L2 and the folding line L1. Similarly, the second part 12 is further divided into two parts (two parts overlapping with each other in the folded-in-quarters state) by the folding line L3. Specifically, the second part 12 is divided into a part 121 between the folding line L1 and the folding line L3 and a part 122 between the folding line L3 and the edge portion 10b of the second part 12.

In this example, as shown in FIG. 14, when viewed from the front surface 2a side of the main body portion 10A, the folding lines L1 and L3 correspond to a mountain folding line, and the folding line L2 corresponds to a valley folding line. That is, when viewed from the front surface 2a side of the main body portion 10A, the main body portion 10A is first mountain folded along the folding line L1, and accordingly, the main body portion 10A can be in a folded-in-half state (refer to FIG. 6 and (A) of FIG. 7). In the folded-in-half state, the two folding lines L2 and L3 are disposed to overlap with each other. The main body portion 10A is further folded in half along the folding lines L2 and L3 from the folded-in-half state to be in a folded-in-quarters state shown in FIG. 14. According to the configuration in which the two folding lines L2 and L3 for further folding the main body portion 10A in half from the folded-in-half state to the folded-in-quarters state are formed on both sides sandwiching the folding line L1 as described above, the pet sheet 1 can be folded more compactly, and thus the storage property and the storage ability of the pet sheet 1 can be improved.

In addition, in the main body portion 10A configured to be able to be in a folded-in-quarters state (refer to FIG. 14) as described above, the bonding surface 7a is disposed not to overlap with any of the folding lines L1, L2, and L3. In the examples of FIGS. 13 and 14, each bonding surface 7a is disposed outside the folding lines L2 and L3 (that is, the part 111 and the part 122). According to the above configuration, since the bonding surface 7a is not deformed (not folded) even when the main body portion 10A is in a folded-in-quarters state, the parallel state of the bonding surface 7a can be appropriately maintained. As a result, it is possible to avoid the bonding function of the bonding surface 7a with respect to the treatment sheet 100 from being impaired by being in the folded-in-quarters state.

In addition, one folding line L2 of the two folding lines L2 and L3 is a third folding line (that is, the line corresponding to the valley folding line when viewed from the front surface 2a side) for folding the main body portion 10A such that the top sheet 2 becomes an inner side in the folded-in-quarters state. The bonding surface 7a is provided at least in a region (that is, the part 111) opposite to a side where the folding line L1 is positioned with respect to the third folding line (folding line L2). In the above configuration, the bonding surface 7a is disposed on the back surface 3a at least in a region (that is, the part 111) where a crease is formed to fold in a direction away from the treatment sheet 100 when the pet sheet 1 is used by overlapping with the treatment sheet 100. Accordingly, it is possible to store the pet sheet 1 in a folded-in-quarters state, while preventing the part 111 of the pet sheet 1 from rolling up from the treatment sheet 100 when the pet sheet 1 is opened from the folded-in-quarters state and used.

### (Package)

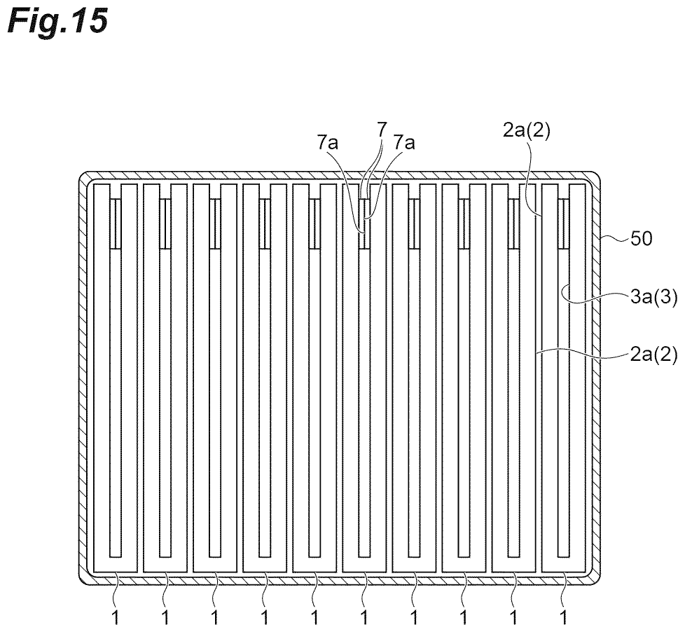

FIG. 15 is a schematic view showing an example of a package 50 accommodating the plurality of (10 as an example) pet sheets 1. The package 50 is formed in, for example, a bag shape having a substantially rectangular parallelepiped shape in a state of accommodating the plurality of pet sheets 1. The package 50 is formed of, for example, a synthetic resin such as polyethylene, polypropylene, or polyethylene terephthalate. For example, a break line (not shown) is formed at a predetermined position in the package 50, and it is possible to form an opening for taking out the pet sheet 1 accommodated in the package 50 by breaking the package 50 along the break line.

The package 50 accommodates the plurality of pet sheets 1 in the following manner. That is, the plurality of pet sheets 1 accommodated in the package 50 is arranged such that the top sheets 2 (front surfaces 2a) of the adjacent pet sheets 1 are in surface contact with each other in a folded state (in the example of FIG. 15, a state similar to the folded-in-half state (FIG. 6) of the above embodiment) where each of the back surface 3a is folded to become an inner side. In addition, in FIG. 15, the top sheets 2 (front surfaces 2a) of the adjacent pet sheets 1 are separated from each other, and a slight gap is formed between the adjacent pet sheets 1. However, actually, the top sheets 2 (front surfaces 2a) of the adjacent pet sheets 1 are in contact (surface contact) with each other.

When the bonding surface 7a of one pet sheet 1 accommodated in the package 50 comes into contact with the adjacent pet sheet 1, when the one pet sheet 1 is pulled out, the bonding surface 7a of the one pet sheet 1 rubs against (or sticks to) the adjacent pet sheet 1, which may cause a problem that the one pet sheet 1 cannot be appropriately pulled out. On the other hand, by arranging and accommodating the plurality of pet sheets 1 such that the top sheets 2 (front surfaces 2a) of the adjacent pet sheets 1 are in surface contact with each other, the package 50 can realize a configuration in which the bonding surface 7a of one pet sheet 1 is less likely to come into contact with the adjacent pet sheet 1, and thus the above-described problem can be avoided. As a result, it is possible to improve the convenience of the user who intends to take out the pet sheet 1 from the package 50 and use the pet sheet 1.

In addition, in the example of FIG. 15, since the pet sheet 1 is folded along the folding line L1 to completely overlap with the back surface 3a, the bonding surface 7a of the pet sheet 1 is not exposed to the outside in the folded state (that is, in a state of being accommodated in the package 50). According to the above configuration, since it is possible to reliably prevent the bonding surface 7a of one pet sheet 1 accommodated in the package 50 from coming into contact with the adjacent pet sheet 1, it is possible to appropriately and easily pull out one pet sheet 1 from the package 50.

As described above, the bonding surface 7a of the pet sheet 1 accommodated in the package 50 may be an adhesive surface. In addition, a cover sheet such as a release paper covering the bonding surface 7a may be provided on the bonding surface 7a. Also in such a case, an effect of reducing the time and effort of the user is exerted as follows. That is, since the plurality of pet sheets 1 are accommodated in the package 50 in a state where each of the pet sheets 1 is folded such that the back surface 3a is hidden on the inner side (that is, the bonding surface 7a and the cover sheet covering the bonding surface 7a are not exposed to the outer side), it is possible to avoid a problem that when one pet sheet 1 is pulled out, the cover sheet rubs against another adjacent pet sheet 1, and the other pet sheet 1 is damaged, or the cover sheet is unintentionally peeled off. As a result, it is possible to improve the convenience of the user who intends to take out the pet sheet 1 from the package 50 and use the pet sheet 1.

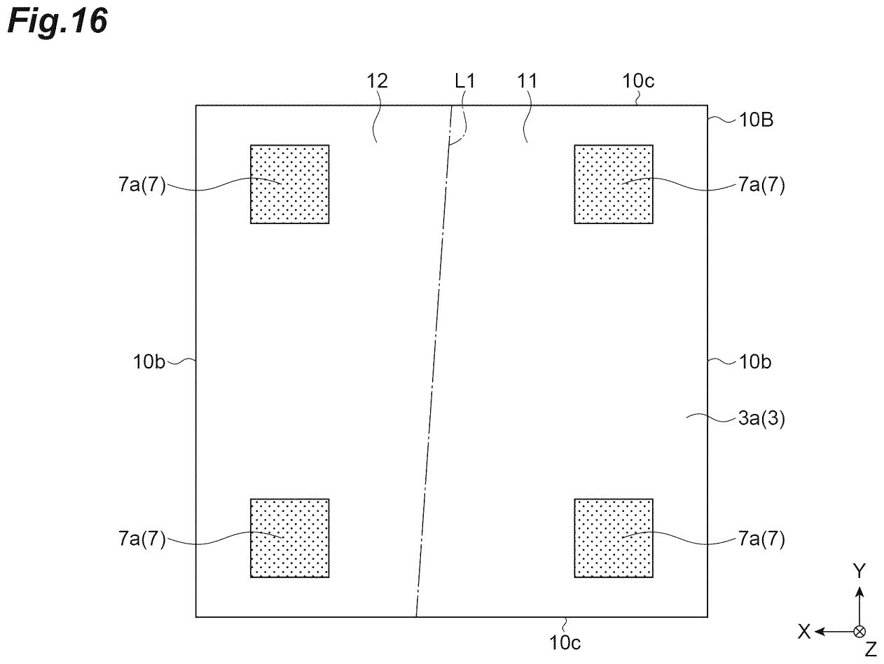

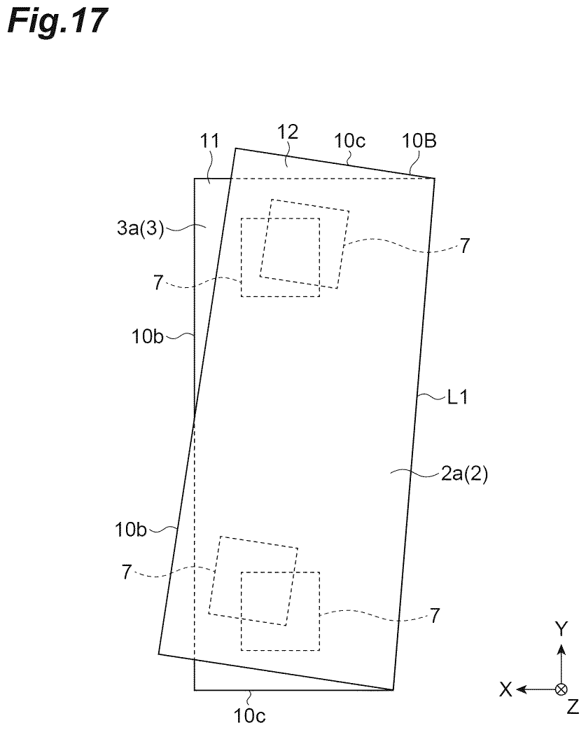

In addition, the pet sheet 1 (main body portion) may be configured such that at least a part of the back surface 3a is exposed to the outside in the folded state. Hereinafter, the main body portion 10B as an example of the above configuration will be described with reference to FIGS. 16 and 17. FIG. 16 is a plan view of the main body portion 10B in the unfolded state as viewed from the back surface 3a side. FIG. 17 is a plan view of the main body portion 10B in the folded state (folded-in-half state) as viewed from the same direction as in FIG. 16. As shown in FIG. 16, the main body portion 10B is mainly different from the main body portion 10 in that the folding line L1 inclined with respect to the edge portion 10b is provided. That is, the main body portion 10B does not have a line-symmetrical shape with respect to the folding line L1, and is configured such that the first part 11 and the second part 12 do not completely overlap with each other when the main body portion 10B is folded in half along the folding line L1. That is, as shown in FIG. 17, a part of the back surface 3a of the main body portion 10B is exposed to the outside. As described above, by configuring the main body portion 10B of the plurality of pet sheets 1 accommodated in the package 50 such that at least a part of the back surface 3a is exposed to the outside in the folded state, it is possible to obtain the above-described effects due to the bonding surface 7a not being exposed to the outside, and the following additional effects. That is, after the pet sheet 1 is taken out from the package 50, a part of the back surface 3a exposed to the outside in the folded state in the pet sheet 1 functions as a knob part, and thus the pet sheet 1 can be easily unfolded from the folded-in-half state. In addition, when the pet sheet 1 is taken out from the package 50, the pet sheet 1 can be easily taken out by pulling the knob part.

### REFERENCE SIGNS LIST

1 Pet sheet
2 Top sheet
2a Front surface
3 Back sheet
3a Back surface
4 Absorbent body
7a Bonding surface
10, 10A, 10B Main body portion
10a Edge portion (first edge portion)
10b Edge portion (second edge portion)
10c Edge portion (third edge portion)
11 First part
12 Second part
50 Package
71 Hook
72 Hook sheet
100 Treatment sheet (animal excreta treatment sheet)
A1 Region (first region)
A2 Region (second region)
A3, A5 Bonding region
A4, A6 Non-bonding region
E Sheet edge portion
F Flap portion
L1 Folding line
L2 Folding line (second folding line, third folding line)
L3 Folding line (second folding line)
U Excreta

1. A pet sheet used by overlapping with a region where excreta is absorbed in an animal excreta treatment sheet that absorbs the excreta of animals, the pet sheet comprising
a main body portion including a liquid-permeable top sheet, a back sheet positioned on a side opposite to the top sheet, and an absorbent body disposed between the top sheet and the back sheet, wherein
the back sheet has a back surface facing a side opposite to a side facing the top sheet,
a bonding surface to be bonded to the animal excreta treatment sheet is provided on the back surface in a state of being exposed to an outside,
a folding line for folding the main body portion in half is formed on the main body portion such that the back surface becomes an inner side, and
the bonding surface is configured such that, when a first part positioned on one side with respect to the folding line in the main body portion is positioned above a second part positioned on an other side with respect to the folding line in the main body portion, in a case where only the first part of the main body portion, which is in a folded-in-half state of being folded in half along the folding line, is retained, the second part is naturally separated from the first part, thereby releasing the folded-in-half state.

2. The pet sheet according to claim 1, wherein
the bonding surface is disposed such that at least a part of the bonding surface disposed in the first part and a part of the bonding surface disposed in the second part face each other in the folded-in-half state, and
a bonding strength between the bonding surfaces is set such that the second part is separated from the first part by its own weight of the second part and the folded-in-half state is released when the first part is positioned above the second part, in a case where only the first part of the pet sheet in the folded-in-half state is retained.

3. The pet sheet according to claim 1, wherein
the bonding surface is disposed on the back surface such that the bonding surfaces do not face each other in the folded-in-half state.

4. The pet sheet according to claim 1, wherein
in a region along a second edge portion on a side opposite to a first edge portion along the folding line of the main body portion in the folded-in-half state, a length along the second edge portion of a bonding region provided with the bonding surface is shorter than a length along the second edge portion of a non-bonding region which is not provided with the bonding surface.

5. The pet sheet according to claim 1, wherein
in a region along a third edge portion connected to a first edge portion along the folding line of the main body portion in the folded-in-half state and intersecting the first edge portion, a length along the third edge portion of a bonding region provided with the bonding surface is shorter than a length along the third edge portion of a non-bonding region which is not provided with the bonding surface.

6. The pet sheet according to claim 1, wherein
the bonding surface is disposed not to overlap with the folding line.

7. The pet sheet according to claim 1, wherein
the bonding surface is a hook surface provided with a plurality of hooks.

8. The pet sheet according to claim 7, wherein
a height of the hook is 45 μm to 350 μm.

9. The pet sheet according to claim 7, wherein
the back surface has a non-bonding surface which is not provided with the bonding surface, and
at least a part facing the bonding surface in the folded-in-half state in the non-bonding surface is formed of a film that does not engage with the hook.

10. The pet sheet according to claim 7, wherein
the hook surface is formed by a surface of a hook sheet adhering to the back surface,
the hook sheet has a sheet edge portion along an edge portion different from a first edge portion along the folding line of the main body portion in the folded-in-half state, and
the sheet edge portion does not adhere to the back surface.

11. The pet sheet according to claim 1, wherein
in the main body portion, two second folding lines for further folding the pet sheet in half again from the folded-in-half state into a folded-in-quarters state are formed on both sides sandwiching the folding line.

12. The pet sheet according to claim 11, wherein
the bonding surface is disposed not to overlap with both the folding line and the two second folding lines.

13. The pet sheet according to claim 11, wherein
the two second folding lines include a third folding line for folding the main body portion such that the top sheet becomes an inner side in the folded-in-quarters state, and
the bonding surface is provided at least in a region on a side opposite to a side where the folding line is positioned with respect to the third folding line.

14. The pet sheet according to claim 1, wherein
a region along a second edge portion on a side opposite to a first edge portion along the folding line of the main body portion in the folded-in-half state has a color tone different from a region where the absorbent body is disposed when viewed from the top sheet side.

15. The pet sheet according to claim 14, wherein
a region excluding a region along the second edge portion in a region along a third edge portion connected to the first edge portion and intersecting the first edge portion has a same color tone as a region where the absorbent body is disposed when viewed from the top sheet side.

16. The pet sheet according to claim 14, wherein
rigidity of a region along the second edge portion in the main body portion is lower than rigidity of a region where the absorbent body is disposed in the main body portion.

17. The pet sheet according to claim 1, wherein
a proportion of cellulose fibers having a hydroxyl group in the absorbent body is 35% or less.

18. A pet sheet used by overlapping with a region where excreta is absorbed in an animal excreta treatment sheet that absorbs the excreta of animals, the pet sheet comprising
a main body portion including a liquid-permeable top sheet, a back sheet positioned on a side opposite to the top sheet, and an absorbent body disposed between the top sheet and the back sheet, wherein
the back sheet has a back surface facing a side opposite to a side facing the top sheet,
a bonding surface to be bonded to the animal excreta treatment sheet is provided on the back surface in a state of being exposed to an outside,
a folding line that enables the main body portion to be folded in half is formed on the main body portion such that the back surface becomes an inner side,
the bonding surface is disposed such that, in a folded-in-half state folded in half along the folding line, a part of the bonding surface disposed in a first part of the main body portion positioned on one side with respect to the folding line faces a part of the bonding surface disposed in a second part of the main body portion positioned on an other side of the folding line, and
an edge portion of the main body portion parallel to the folding line is formed by a flap portion where the absorbent body is not provided.

19. A package accommodating a plurality of pet sheets used by overlapping with a region where excreta is absorbed in an animal excreta treatment sheet which absorbs the excreta of animals, wherein
the pet sheet includes:
a liquid-permeable top sheet;
a back sheet positioned on a side opposite to the top sheet; and
an absorbent body disposed between the top sheet and the back sheet,
the back sheet has a back surface facing a side opposite to a side facing the top sheet,
a bonding surface to be bonded to the animal excreta treatment sheet is provided on the back surface, and
the plurality of pet sheets accommodated in the package are arranged such that the top sheets of the adjacent pet sheets are in surface contact with each other in a folded state where each of the back surfaces becomes an inner side.

20. The package according to claim 19, wherein
the bonding surface of the pet sheet is not exposed to an outside in the folded state.

21. The package according to claim 20, wherein
at least a part of the back surface of the pet sheet is exposed to the outside in the folded state.
